(19) United States
(12) Patent Application Publication
(10) Pub. No.: US 2014/0299391 A1
(43) Pub. Date: Oct. 9, 2014

(54) PATIENT TRANSPORT DEVICES

(71) Applicant: Enrico Carletti, Pieve di Cento (IT)

(72) Inventor: Enrico Carletti, Pieve di Cento (IT)

(73) Assignee: FERNO-WASHINGTON, INC., Wilmington, OH (US)

(21) Appl. No.: 14/238,297

(22) PCT Filed: Aug. 15, 2012
(86) PCT No.: PCT/US2012/050904

§ 371 Date: Mar. 19, 2014

Related U.S. Application Data
(60) Provisional application No. 61/523,430, filed on Aug. 15, 2011.

(51) Int. Cl. A61G 5/04; A61G 5/06; A61G 5/10

(52) U.S. Cl. CPC A61G 5/04; A61G 5/10; A61G 5/061
USPC 180/6.7

(57) ABSTRACT

Embodiments of a patient trans- port device comprise a rigid structural member; a patient support member coupled to the rigid structural member, a propulsion assembly coupled to the rigid structural member, wherein the rigid structural member comprises a motor operable to oscillate between frontward rotation and backward rotation, first and second continuous tracks responsive to the motor and rotatably coupled to the rigid structural member, and a power source configured to energize the motor and exchange electrical energy with the motor, and at least one controller communicatively coupled with the power source and programmed to execute machine readable instructions to oscillate the motor between frontward rotation and backward rotation, the oscillation of the motor being operable to cause the first continuous track and the second continuous track to stop.

### CROSS-REFERENCE TO RELATED APPLICATIONS

The present application claims priority to U.S. Provisional Application No. 61/523,430 filed Aug. 15, 2011, the entirety of which is incorporated by reference herein in its entirety.

### TECHNICAL FIELD

The present specification generally relates to patient transport devices for transporting a person up and down a flight of stairs and over a surface.

### BACKGROUND

Patient transportation devices may be utilized by operators who respond to requests for assistance from, for example, injured or incapacitated people. People who require such assistance may be found in a variety of locations. Accordingly, patient transport devices may transport a supported patient over various surfaces and obstacles encountered during an evacuation such as, for example, a flight of stairs.

Some evacuations may require multiple trips down and up flights of stairs. Moreover, the probability of encountering an individual who is either overweight or obese appears to be increasing. Thus, operators may require motive assistance from the patient transport device in order to avoid fatigue.

Accordingly, a need exists for alternative patient transport devices for transporting a person up and down a flight of stairs and over a surface.

### SUMMARY

The embodiments described herein address are directed to patient transport devices with improved features that facilitate easier control and transport of patients, specifically the transport of patients over inclined surfaces such as stairs.

According to one embodiment, the patient transport device comprises a rigid structural member; a patient support member coupled to the rigid structural member, a propulsion assembly coupled to the rigid structural member, wherein the rigid structural member comprises a motor operable to oscillate between frontward rotation and backward rotation, first and second continuous tracks responsive to the motor and rotatably coupled to the rigid structural member, and a power source configured to energize the motor and exchange electrical energy with the motor, and at least one controller communicatively coupled with the power source and programmed to execute machine readable instructions to oscillate the motor between frontward rotation and backward rotation, the oscillation of the motor being operable to cause the first continuous track and the second continuous track to stop.

These and additional features provided by the embodiments of the present disclosure will be more fully understood in view of the following detailed description, in conjunction with the drawings

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a patient transport device according to one or more embodiments shown and described herein;

FIG. 2 schematically depicts a propulsion assembly according to one or more embodiments shown and described herein;

FIG. 3 schematically depicts a propulsion assembly according to one or more embodiments shown and described herein

FIG. 4 schematically depicts a patient transport device according to one or more embodiments shown and described herein; and

FIG. 5 schematically depicts a motor in a disassembled state according to one or more embodiments shown and described herein.

### DETAILED DESCRIPTION

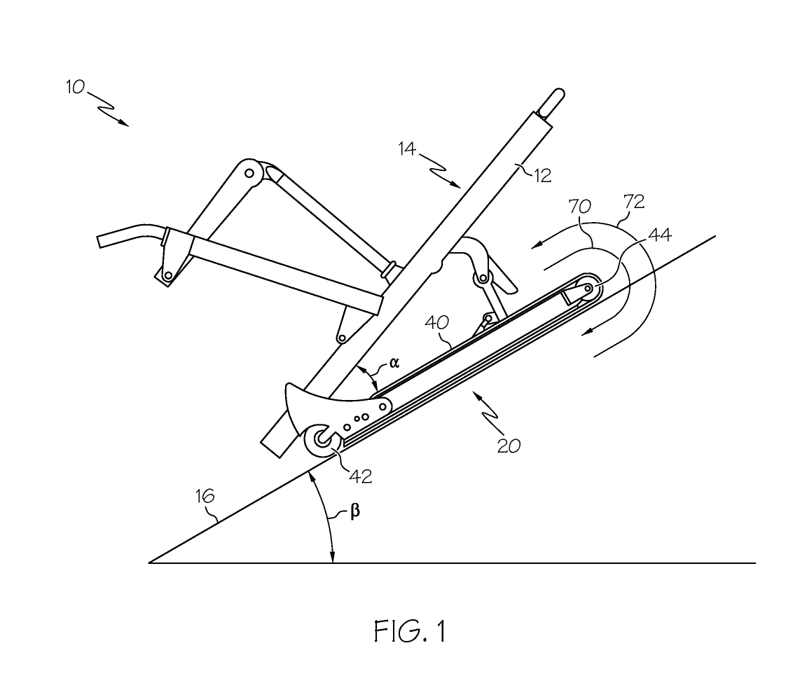

FIG. 1 generally depicts one embodiment of a patient transport device for transporting a person up and down a flight of stairs and over a ground surface. The patient transport device generally comprises a rigid structural member, a patient support member, a propulsion assembly, a power source, and at least one controller. Various embodiments of the patient transport device and the operation of the patient transport device will be described in more detail herein.

Referring now to FIG. 1, a patient transport device 10 is schematically depicted. The patient transport device 10 comprises a rigid structural member 12. The rigid structural member 12 may be coupled to other members to form a frame suitable to support the weight of a patient, which in cases of bariatric patients may be in excess of 600 lbs. The rigid structural member 12 is configured to resist twisting and/or bending when subjected to compressive, tensile and/or shear stresses as the result of an applied load. The rigid structural member 12 may comprise any material suitable for supporting a patient such as, for example, steel, aluminum, or composite materials. It is noted that, while the rigid structural member 12 is depicted as a square profile tube, the rigid structural member 12 may include any profile such as, for example, I-beam, C-channel, circular profile tube, right angle, and the like.

The rigid structural member 12 of the patient transport device 10 may be coupled to a patient support member 14. The patient support member 14 may be any device for holding and/or carrying a patient such as, for example, a seat for transporting a patient in a seated position or a flat surface for transporting a patient in a prone position. The patient support member 14 may comprise materials that are cleanable and resistant to stains from, for example, blood and bodily fluids such as, for example, high-density polyethylene, ABS plastic, nylon, vinyl and the like. Accordingly, it is noted that, while the patient transport device 10 is depicted in FIG. 1 as a stair chair, the patient transport device 10 may be a stair chair, a stretcher, a cot, or any other device capable of transporting an injured or incapacitated patient.

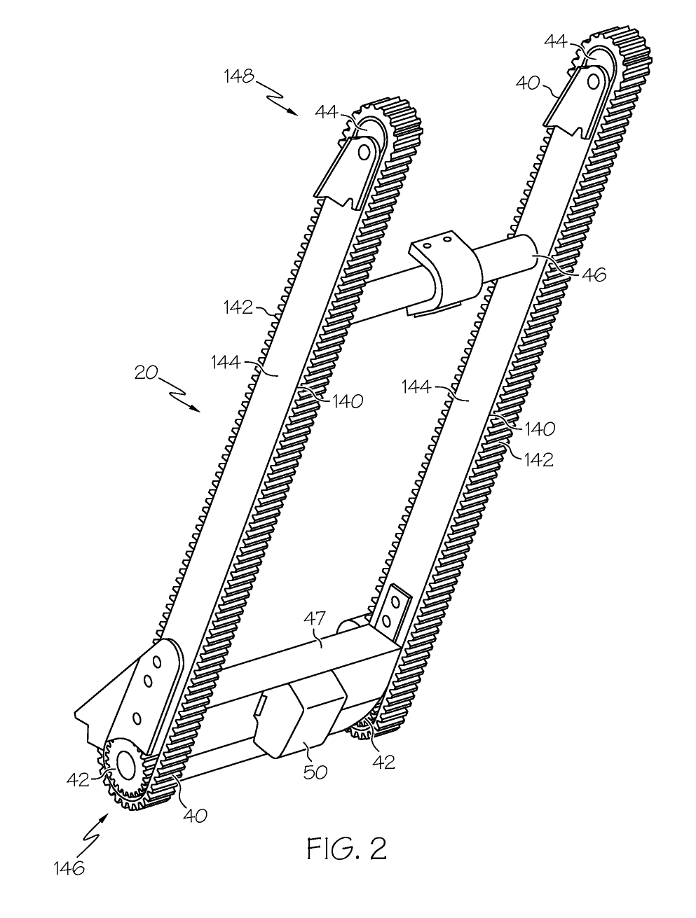

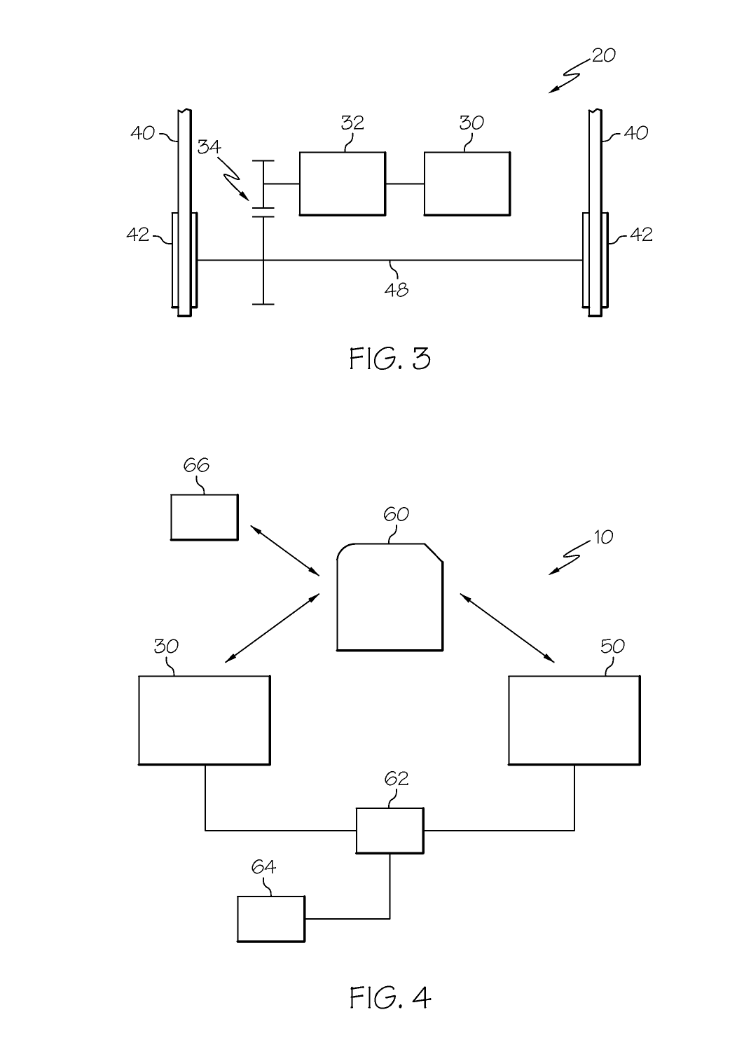

The patient transport device 10 further comprises a propulsion assembly 20 for assisting with the transport of a person up and down a flight of stairs and over a ground surface. Referring collectively to FIGS. 1-3, the propulsion assembly 20 comprises a continuous track 40 (FIGS. 1 and 2) engaged with a motor 30 (FIG. 3). During normal operation, the continuous tracks 40 are aligned with the rigid structural member 12 at an acute angle α. In some embodiments, the continuous tracks 40 may be rotatably coupled to the rigid structural member 12 such that the continuous tracks 40 can lock in a deployed state and stowed state with respect to the rigid structural member 12, as is described in International Application No. PCT/US2011/036230 which is commonly owned herewith and is incorporated herein by reference. In further embodiments, the continuous tracks 40 may be fixed with respect to the rigid structural member 12. In still further embodiments, the propulsion assembly 20 may be removably attached to the rigid structural member 12.

Referring now to FIG. 2, the continuous track comprises a drive surface 140 for engaging the drive wheel 42 of the propulsion assembly 20 and a frictional surface 142 for traversing over stairs, surfaces and obstacles such as, for example, door sills and gutters. The drive surface 140 and the frictional surface 142 may include surface enhancements configured to control the friction of drive surface 140 and the frictional surface 142. For example, the drive surface 140 and the frictional surface 142 of the continuous track 40 may be toothed to provide additional friction with the drive wheel 42 and/or stairs, as is described in U.S. Pat. No. 7,520,347 which is commonly owned herewith and is incorporated herein by reference. Alternatively or in addition, the drive surface 140 and the frictional surface 142 of the continuous track 40 may be smooth, notched, grooved or perforated.

Referring to FIG. 3, the motor 30 of the propulsion assembly 20 is engaged with the continuous track 40 and operable to propel the continuous track 40. For example, as is explained in greater detail herein, the motor may be engaged with the continuous track 40 via a gearbox 32, a gear assembly 34, a drive axle 48 and the drive wheel 42. The motor 30 rotates in a frontward rotation and a backward rotation. Generally, a frontward rotation of the motor 30 corresponds to motion of the continuous track 40 in the forward direction 70 (FIGS. 1 and 2), and a backward rotation of the motor 30 corresponds to motion of the continuous track 40 in the reverse direction 72 (FIGS. 1 and 2). However, it is noted that, while a particular rotation of the motor 30 corresponds to a particular direction of motion of the continuous track 40, the motor 30 may rotate in a direction different than the continuous track 40.

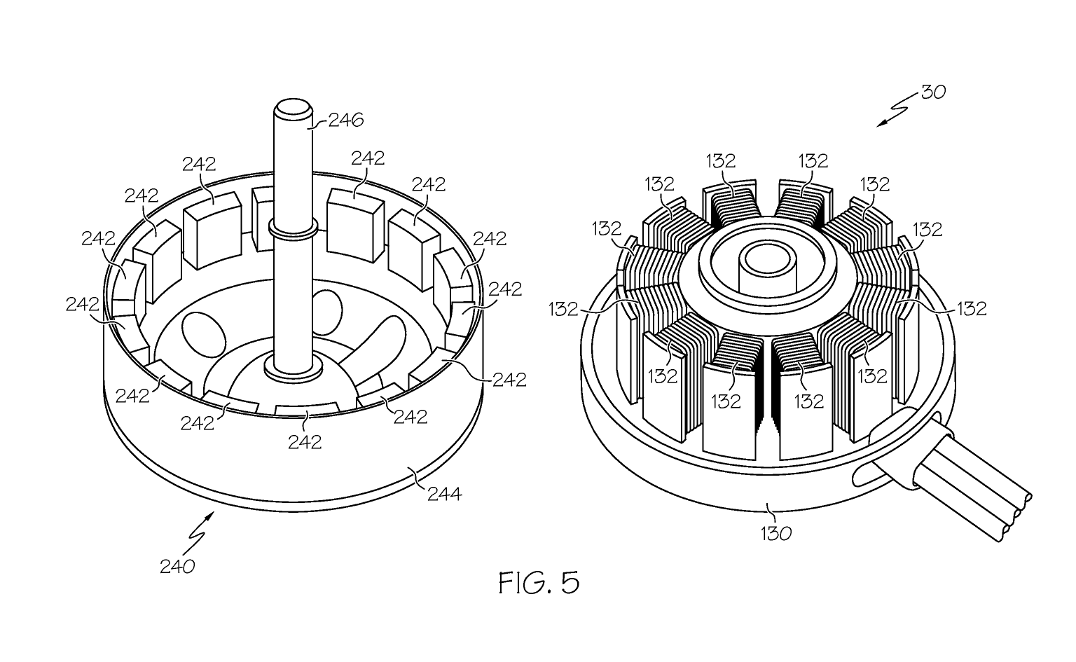

The motor 30 may be any device capable of a transforming electrical energy into mechanical motion such as, for example, DC motors or AC motors. Referring to FIG. 5, the motor 30 may be a brushless DC motor. The motor 30 may comprise a stator 130 and a rotor 240 such that the stator 130 and the rotor 240 magnetically interact during motion of the rotor 240 with respect to the stator 130. For example, when electrical energy is supplied to the stator 130, the rotor 240 may rotate with respect to the stator 130. The stator 130 may include a plurality of armatures 132. Each of the armatures 132 may include a conductive winding. The rotor 240 may include a plurality of magnets 242 and a shaft 246 coupled to a rotor casing 244. Accordingly, when current is provided through at least one of the armatures 132, a magnetic field may be generated by the current. The magnetic field generated by the current may interact with the magnetic field of at least one of the magnets 242 to induce motion of the rotor casing 244 and the shaft 246 with respect to the stator 132. Alternatively, when the magnets 242 are rotated with respect to an armature 132 of the stator 130, the motion of the magnets 242 may generate a magnetic field. The magnetic field of at least one of the magnets 242 may induce a current in at least one of the armatures 132. It is noted that the magnets 242 may be permanent magnets such as, for example, a rare earth magnet, which may comprise neodymium or samarium-cobalt.

Referring now to FIG. 4, the patient transport device 10 further comprises a power source 50 for exchanging electrical energy with the motor 30. The power source 50 may be a rechargeable battery having a pre-determined voltage level such as, for example, 12 V, 18 V, 28 V, or 36 V. Other suitable voltages are contemplated, especially as battery capacities increase over time. Accordingly, the power source 50 may comprise lead-acid, nickel cadmium, nickel metal hydride, lithium ion, or lithium ion polymer.

The patient transport device 10 comprises at least one controller 60 for executing machine readable control logic to perform functions or to cause communicably coupled devices to perform functions. The at least one controller 60 may be an integrated circuit, a microprocessor, microchip, a computer, or any other computing device capable of executing machine readable instructions. The machine readable instructions may be stored in a memory. The memory may comprise volatile or non-volatile memory such as, for example, RAM, ROM, a flash memory, a hard drive, a register or any device capable of storing machine readable instructions.

It is noted that, while the at least one controller 60 is depicted in FIG. 4 as a discrete component communicatively coupled (depicted in FIG. 4 as arrows) with the power source 50 and the user interface device 66, additional controllers and additional memories may be integral with any of the at least one controller 60, the motor 30, the power source 50, the switching device 62, the shunt circuit 64 and the user interface device 66 without departing from the scope of the present disclosure. Furthermore, it is noted that the phrase “communicatively coupled,” as used herein, means that components are capable of exchanging data signals with one another such as, for example, electrical signals via conductive medium, electromagnetic signals via air, optical signals via optical waveguides, and the like.

The machine readable instructions may comprise logic or an algorithm written in any programming language of any generation (e.g., 1GL, 2GL, 3GL, 4GL, or 5GL) such as, for example, machine language that may be directly executed by the at least one controller 60, or assembly language, object-oriented programming (OOP), scripting languages, microcode, etc., that may be compiled or assembled into machine readable instructions and stored on a machine readable medium. Alternatively or additionally, the at least one controller 60 may comprise hardware encoded with the machine readable instructions, i.e., the logic or algorithm may be written in a hardware description language (HDL), such as implemented via either a field-programmable gate array (FPGA) configuration or an application-specific integrated circuit (ASIC), and their equivalents.

Referring again to FIG. 3, the motor 30 may be engaged with the continuous track 40 via a plurality of components for transferring mechanical energy such that rotation of the motor 30 is linked to motion of the continuous track 40. In one embodiment, the motor 30 is engaged with a gearbox 32. The gearbox 32 may be any device suitable for converting the speed and torque output from the motor 30 to a different speed and/or torque. In one embodiment, the gearbox 32 transfers the output of the motor 30 to the gear assembly 34, which rotatably engage the drive axle 48 and the gearbox 32. The gearbox 32 may transform the output rotational speed from the motor 30 to a slower rotational speed. Accordingly, the gearbox may allow the motor 30 to rotate at a relatively higher speed than the drive axle 48. Additionally, the gearbox 32 may transform a torque produced by the motor 30 into an increased torque that is delivered to the drive axle 48 by the gear assembly 34. It is noted that the motor 30 may be oriented in any direction with respect to the drive axle 48 such as, substantially parallel, substantially perpendicular, or any orientation there between.

In some embodiments, the propulsion assembly 20 may comprise a single drive axle 48 coupled to two drive wheels 42, which may cause the drive axle 48 and the drive wheels 42 to rotate at a substantially same speed. Each of the drive wheels 42 may drive a continuous track 40 at substantially the same speed. It is noted that the drive wheel 42 may be toothed (i.e., a sprocket) or comprise a frictional enhancement configured to increase the friction between the drive wheel 42 and the continuous track 40 such as grooves or treads.

Referring again to FIG. 2, the propulsion assembly 20 may further comprise a track body 144 for providing a structure to operably couple the components of the propulsion assembly 20. For example, the propulsion assembly may comprise a pair of track bodies 144. Each track body 144 may be rotatably coupled to a drive wheel 42 at a foot end 146 of the track body 144 and a guide wheel 44 at the head end 148 of the track body 144. Additional frame members may be coupled to the propulsion assembly 20 to increase robustness of the propulsion assembly 20. A first cross member 46 may be coupled to each of the track bodies 144 such that the first cross member 46 is spaced apart from the drive wheels 42 towards the head end 148 of each of the track bodies 144. A second cross member 47 may be coupled to each of the track bodies 144 such that the second cross member 47 is spaced apart from the first cross member 46 and located towards the foot end 146 of each of the track bodies 144. Accordingly, the first cross member 46 and the second cross member 47 may ensure that the continuous tracks 40 are aligned with respect to one another and provide a structural frame that resists bending and/or twisting during operation.

Referring collectively to FIGS. 1 and 4, the patient transport device 10 may travel over an incline 16 (e.g., a stairwell) having an angle of incline of β. It is noted that, while the angle of incline of β is depicted in FIG. 1 as being about 30°, the angle of incline of β may be any angle less than or equal to about 90°. As the patient transport device 10 ascends the incline 16, the continuous track 40 of the propulsion assembly 20 may move in the forward direction 70. As the patient transport device 10 descends the incline 16, the continuous track 40 of the propulsion assembly 20 may move in the reverse direction 72. The motor 30 may propel the continuous track 40 in the forward direction 70 or the reverse direction 72.

Specifically, the user interface device 66, which may be communicably coupled to the at least one controller 60, may detect that a user intends to actuate the continuous track 40 in the forward direction 70 and generate a signal indicative of motion in the forward direction 70. The at least one controller 60 may receive the signal indicative of motion in the forward direction 70 from the user interface device 66. The at least one controller 60 may then transmit a control signal to cause the motor 30 to rotate in a frontward rotation to actuate the continuous track 40 in the forward direction 70. The user interface device 66, the at least one controller 60 and the propulsion assembly 20 may cooperate in a substantially similar manner to actuate the continuous track 40 in the reverse direction 72. It is noted that the user interface device 66 may be any device configured to detect the intended motion of the patient transport device 10. The user interface device 66 may comprise buttons, switches, pressure sensors, motion detectors, display screens, touch screens, and the like. For example, the user interface device 66 may include a button and a display screen mounted to a handle portion of a stair chair.

The at least one controller 60 can execute machine readable instructions to cause the continuous track 40 of the propulsion assembly 20 to stop. The at least one controller 60 may be communicably coupled to the motor 30 and/or the power source 50 and cause the motor to oscillate between the frontward rotation and the backward rotation. For example, rather than applying a DC current to the motor 30, the direction of the current may be alternated at a frequency such that the direction of the current supplied to the motor 30 is changed substantially faster than the time required for the motor 30 to overcome inertia and actuate the continuous track 40 in the forward direction 70 of the reverse direction 72. In some embodiments, the at least one controller may cause the continuous track 40 to stop based upon a signal indicative of a stop command transmitted by the user interface device 66. In further embodiments, the at least one controller may cause the continuous track 40 to stop unless a motive signal is received from the user interface device 66. For example, the patient transport device 10 may have a default state wherein the at least one controller causes the continuous track 40 to stop when the patient transport device is powered by the power source 50, i.e., when the patient transport device is turned on. The default condition may be changed may providing an alternative state such as a signal received from the user interface device 66.

The patient transport device 10 may include a manual state wherein the continuous track 40 and the motor 30 may be moved by an externally applied force. In one embodiment, the at least one controller 60 can execute machine readable instructions to allow the continuous track 40 to be driven in the reverse direction 72 and the motor to be rotated in a backward rotation. When the motor 30 is manually rotated and no current is supplied to the motor, the motor 30 may generate a current that can be applied to a load. For example, the rotating magnets of the motor 30 may induce a time varying magnetic field. The time varying magnetic field may induce a current in stationary conductive coils that interact with the time varying magnetic field. The induced current may generate a second magnetic field, which resists the rotation of the motor 30 by interacting with the magnetic field of the rotating magnets. Without being bound to theory, it is believed that the greater the rate of change of the time varying magnetic field (i.e., the faster the rotation of the magnets), the greater the resistance to rotation of the motor 30. Accordingly, when the patient transport device is in the manual state (e.g., the motor is not supplied with power), the motor 30 may generate a current that resists movement of the continuous track 40, but does not prevent movement of the continuous track 40, i.e., an electromotive force may resist motion. For example, the resistance may be utilized to regulate the speed of the continuous track 40 as the patient transport device 10 descends a flight of stairs. In further embodiments, this resistance generated by the electromotive force is highly effective in emergency situations (for example, when the controller is broken or the battery is discharged), because the patient transport device may function independently of the controller.

The motor 30 may be electrically coupled to the power source 50. Thus, when the patient transport device is in the manual state, the current generated by the motor 30 may be supplied to the power source 50 to replenish any depleted electrical energy, i.e., a battery may be recharged. As is noted above, the amount of electrical energy generated by the motor 30 is dependent upon the rotational speed of the motor 30. Accordingly, the amount of energy supplied by the motor 30 may be in excess of what is necessary to replenish the power source 50.

Accordingly, as depicted in FIG. 4, the electrical energy generated by the motor may be selectively applied to the power source 50 or a shunt circuit 64 configured to dissipate the electrical energy generated by the motor 30. The shunt circuit 64 may comprise resistive elements such as resistors or potentiometers. In one embodiment, the patient transport device 10 may comprise a switching device 62 in electrical communication with the motor 30, the power source 50, and the shunt circuit 64. The switching device 62 may be a relay such as, for example, a current activated relay or a voltage activated relay, or may be communicably coupled to the at least one controller 60. Accordingly, the power source 50 may be protected from excessive voltage by a voltage activated relay. For example, the relay may be configured to decouple the power source 50 from the motor 30 when the voltage supplied to the power source 50 exceeds the rated voltage of the power source 50 by a predetermined amount. The predetermined amount may be from about 2% to about 20%, such as, about 3.5%, about 5%, about 10%, or about 15%.

It should now be understood, that embodiments of the patient transport device described herein may be utilized to transport a patient down and/or up a flight of stairs. The patient transport device may provide sufficient propulsion to transport a patient up a flight of stairs without being pushed by an operator or the patient transport device may provide an amount of propulsion less than what is required to transport a patient up a flight of stairs without being pushed by an operator. For example, the patient transport device may be actuated by an operator and rotate continuous tracks to propel the patient transport device as the operator pushes the patient transport device.

The patient transport device may also automatically stop when the operator is no longer actuating the patient transport device. For example, as the operator is pushing the device up a flight of stairs, the operator may hold a button in an actuated state. If the operator were to release the button, the patient transport device would automatically stop the continuous tracks by pulsing the motor rapidly between a frontward rotation and a backward rotation.

An operator may carry a patient down a flight of stairs in the patient transport device while the patient transport device is in a manual state. For example, as the operator is guiding the patient transport device down a flight of stairs, the operator may hold a button corresponding to the manual state in an actuated state. As the motor is rotated by the continuous tracks, both a current and an electromotive force may be generated. The current may be utilized to charge a battery and the electromotive force may reduce the amount of energy required from the operator to guide the patient transport device. As is noted above, if the operator were to release the button, the patient transport device would automatically stop the continuous tracks by pulsing the motor rapidly between a frontward rotation and a backward rotation.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

In one embodiment, a patient transport device may include a rigid structural member, a patient support member coupled to the rigid structural member, and a propulsion assembly coupled to the rigid structural member. The propulsion assembly may include a motor that rotates in a frontward rotation and a backward rotation and a continuous track engaged with the motor. A power source can be electrically coupled to the motor of the propulsion assembly. At least one controller can be communicably coupled to the motor, the power source or both. The at least one controller can execute machine readable instructions to oscillate the motor between the frontward rotation and the backward rotation, wherein oscillation of the motor causes the continuous track to stop.

In some embodiments, the at least one controller can execute machine readable instructions to allow the continuous track to be driven in a reverse direction, when the motor is not energized by the power source, the motor is rotated in the backward rotation, and the motor generates a current that resists movement of the continuous track in the reverse direction. The current can be supplied to the power source and the power source can be replenished by the current. The patient transport device may include a relay electrically coupled to the power source, the motor and a shunt circuit. When a voltage supplied to the power source by the current is over a predetermined amount, the relay can decouple the power source and the motor, and can couple the power source to the shunt circuit. The shunt circuit may include a resistor or a potentiometer. The motor can be a brushless DC motor. The motor may include a neodymium magnet. The continuous track can be aligned with the rigid structural member at an acute angle. The patient transport device may include a user interface device communicably coupled to the at least one controller. When the patient transport device is powered by the power source, the at least one controller can execute machine readable control logic to oscillate the motor unless an alternative state is provided to the at least one controller by the user interface device. The propulsion assembly may include a first drive wheel engaged with the continuous track, a second drive wheel engaged with another continuous track, and a drive axle coupled to the first drive wheel and the second drive wheel. The drive axle, the first drive wheel and the second drive wheel can rotate at substantially the same speed.

In another embodiment, the patient transport device may include a rigid structural member, a patient support member coupled to the rigid structural member, and a propulsion assembly coupled to the rigid structural member. The propulsion assembly may include a motor that rotates in a frontward rotation and a backward rotation and a continuous track engaged with the motor. A power source can be electrically coupled to the motor of the propulsion assembly. At least one controller can be communicably coupled to the motor, the power source or both. The at least one controller can execute machine readable instructions to oscillate the motor between the frontward rotation and the backward rotation. The motor can be energized by the power source and the oscillation of the motor can cause the continuous track to stop. The at least one controller can execute machine readable instructions to rotate the motor in the frontward rotation when the motor is energized by the power source. The frontward rotation of the motor can drive the continuous track in a forward direction. The at least one controller can execute machine readable instructions to allow the continuous track to be driven in a reverse direction when the motor is not energized by the power source, the motor is rotated in the backward rotation, and the motor generates a current that resists movement of the continuous track in the reverse direction.

In some embodiments, the current can be supplied to the power source and the power source can be replenished by the current. The patient transport device may include a relay electrically coupled to the power source, the motor and a shunt circuit, wherein when a voltage supplied to the power source by the current is over a predetermined amount, the relay decouples the power source and the motor, and couples the power source to the shunt circuit. The shunt circuit may include a resistor or a potentiometer. The motor can be a brushless DC motor. The motor may include a neodymium magnet. The continuous track can be aligned with the rigid structural member at an acute angle.

The patient transport device may include a user interface device communicably coupled to the at least one controller. When the patient transport device is powered by the power source, the at least one controller can execute machine readable control logic to oscillate the motor unless an alternative state is provided to the at least one controller by the user interface device. The patient transport device can be a stair chair or a stretcher.

In yet another embodiment, a patient transport device may include a rigid structural member, a patient support member coupled to the rigid structural member, and a propulsion assembly coupled to the rigid structural member. The propulsion assembly may include a motor that rotates in a frontward rotation and a backward rotation. A first drive wheel can be engaged with a first continuous track. A second drive wheel can be engaged with a second continuous track. A drive axle can be coupled to the first drive wheel and the second drive wheel and rotatably engaged with the motor. The first continuous track and the second continuous track can be aligned with the rigid structural member at an acute angle. A power source electrically can be coupled to the motor of the propulsion assembly. At least one controller can be communicably coupled to the motor, the power source or both. The at least one controller can execute machine readable instructions to oscillate the motor between the frontward rotation and the backward rotation. The motor can be energized by the power source and oscillation of the motor can cause the first continuous track and the second continuous track to stop. The at least one controller can execute machine readable instructions to rotate the motor in the frontward rotation. The motor can be energized by the power source and the frontward rotation of the motor can drive the first continuous track and the second continuous track in a forward direction. The at least one controller can execute machine readable instructions to allow the first continuous track and the second continuous track to be driven in a reverse direction. The motor may not be energized by the power source as the motor is rotated in the backward rotation, and the motor generates a current that resists movement of the first continuous track and the second continuous track in the reverse direction.

Additionally, the patient transporter may comprise one or more drive lights (not shown) communicatively coupled to the controller and the power source and configured to assist the patient and user in dark or dimly lit surroundings. For instance, the patient transporter may comprise front drive lights coupled to the rigid structural member or the patient support member. Accordingly, the front drive light can illuminate an area directly in front of the patient transporter (e.g., stair chair). Alternatively, the patient transporter may also comprise a back drive light communicatively coupled to the controller and power source. The back drive light can be coupled to the rigid structural member or the patient support member, and can illuminate an area behind the patient transporter.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A patient transport device comprising:
a rigid structural member;
a patient support member coupled to the rigid structural member and configured to support a patient disposed thereon;
a propulsion assembly coupled to the rigid structural member, wherein the rigid structural member comprises
a motor operable to oscillate between frontward rotation and backward rotation,
first and second continuous tracks responsive to the motor and rotatably coupled to the rigid structural member, and
a power source configured to energize the motor and exchange electrical energy with the motor; and
at least one controller communicatively coupled with the power source and programmed to execute machine readable instructions to oscillate the motor between frontward rotation and backward rotation, the oscillation of the motor being operable to cause the first continuous track and the second continuous track to stop.

2. The patient transport device of claim 1 wherein the power source is configured to not energize the motor when the motor is in backward rotation, and the motor is configured to generate a current that resists movement of the first continuous track and the second continuous track in a reverse direction.

3. The patient transport device of claim 1 further comprising a user interface device.

4. The patient transport device of claim 3 wherein the user interface device comprises one or more buttons.

5. The patient transport device of claim 3 wherein the oscillation of the motor between frontward rotation and backward rotation operator is triggered by a user's failure to actuate the user interface device, the oscillation being configured to automatically stop the first and second continuous tracks.

6. The patient transport device of claim 1 wherein the motor is manually rotatable without current supplied to the motor, the manual rotation of the motor being configured to generate current which resists but does not prevent movement of the first and second continuous tracks.

7. The patient transport device of claim 6 wherein the current generated by the motor is at least partially supplied to the power source.

8. The patient transport device of claim 6 wherein the current generated by the motor is at least partially supplied to a shunt circuit configured to dissipate the electrical energy generated by the motor.

9. The patient transport device of claim 8 wherein the shunt circuit comprises resistive elements selected from the group consisting of resistors, potentiometers, or combinations thereof.

10. The patient transport device of claim 8 further comprising a switching device in electrical communication with the motor, the power source, and the shunt circuit.

11. The patient transport device of claim 1 wherein the power source is a rechargeable battery.

12. The patient transport device of claim 1 wherein the propulsion assembly is removably coupled to the rigid structural member.

13. The patient transport device of claim 1 wherein the patient support member comprises a seat configured for transporting a patient in a seated position.

14. The patient transport device of claim 1 wherein the patient support member comprises a flat surface operable for transporting a patient in a prone position.

15. The patient transport device of claim 1 wherein the patient transport device is a stair chair.

16. The patient transport device of claim 1 wherein the first and second continuous tracks are aligned with the rigid structural member at an acute angle α.

17. The patient transport device of claim 1 wherein the first and second continuous tracks are operable to lock in a deployed state or stowed state.

18. The patient transport device of claim 1 wherein the first and second continuous tracks each comprise a drive surface configured for engaging a drive wheel of the propulsion assembly and a frictional surface configured for traversing over stairs.

19. The patient transport device of claim 1 wherein the motor is engaged with the first and second continuous tracks via a gearbox, a gear assembly, a drive axle, and a drive wheel.

20. The patient transport device of claim 1 further comprising front and back drive lights.
